(19) United States
(12) Patent Application Publication
(10) Pub. No.: US 2008/0094523 A1
(43) Pub. Date: Apr. 24, 2008

(54) Controllable System Having Functions That Can Be Activated Control Commands

(75) Inventors: Jan Van De Kam, Hertsberge (BE); Paul Ullmann, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,995

(22) PCT Filed: Jul. 11, 2005
(86) PCT No.: PCT/IB05/52287

§ 371 Date: Jan. 12, 2007

(30) Foreign Application Priority Data
Jul. 13, 2004 (EP) 04103341.6

(51) Int. Cl. H04N 5/44

(52) U.S. Cl. 348/734; 348/E05.096

(57) ABSTRACT

The invention relates to a controllable arrangement (1) having functions that can be activated by control commands, comprising: an input system (7) for control commands (CI) and acknowledgment signals (ACK), which input system (7) is connected to a recognition system) (9) for recognizing received control commands (CI) and a detection system (29) for detecting a received acknowledgment signal (ACK), and furthermore containing a request system (28) for requesting an acknowledgment signal (ACK) for a previously received control command, wherein the controllable arrangement (1) contains a command information memory (27) that contains individual command information items (VCMI, A-CMI) representative of the control respective command to be acknowledged, and wherein a control system (25) is connected to the control command recognition system (9) and is intended, for the respective control command (CI) recognized by the recognition means (9) and to be acknowledged, to read out the individual command information item representative of this control command (CI) from the memory (27) and deliver it as acknowledgment request information to the request system (28) in order to request and acknowledgment signal (ACK).

### FIELD OF THE INVENTION

The invention relates to a controllable arrangement having functions that can be activated by control commands, the arrangement comprising input means for control commands and acknowledgment signals, and recognition means connected to the input means in order to recognize received control commands, and detection means for detecting a received acknowledgment signal, and request means for requesting an acknowledgment signal for a previously received control command.

### BACKGROUND OF THE INVENTION

Such an arrangement is known from document US 2002/0015107 A1. Specifically, this known arrangement is a television device with teletext capability, which is intended to simplify requests or access for teletext information or teletext pages by providing program links. In the context of accessing such teletext pages by remote control means, as an extra way of correcting inadvertent actuation of buttons on the remote control means, a prompt can be sent via a display screen of the television device to ask for a first button (an acknowledgement button) to be pressed for acknowledgement or for a second button (a cancel button) to be pressed for canceling the control command previously entered via the remote control means. A disadvantage here is that a user is left uncertain as to which control command was in fact previously entered and that particular buttons have to be pressed for acknowledgement and canceling, and it is necessary to find these in a keypad of the remote control means, which is unfortunately also susceptible to error.

In this context, it should be remembered that relatively extensive keypads with many buttons—corresponding to the multiplicity of possible functions—are usually provided for controlling modem controllable systems having functions that can be activated by control commands, for instance TV sets together with video recorders, hi-fi stereos, DVD players, etc., these buttons being fitted directly on the system and/or the associated remote control means. Further to the fact that mistakes can easily be made—not only by inexperienced individuals—because of the multiplicity of functions and therefore the multiplicity of associated buttons for controlling the systems, especially in consumer electronics, another difficulty is that the lighting in the room is often turned down when watching television films on TV sets, for example, so that the control buttons are also difficult to see, which can also lead to accidental sending of unintended control commands. Notification with a prompt to acknowledge a previously sent control command, for example a function to be activated in association with the actuation, is therefore expedient and other measures should be provided in order to make some important buttons unavailable for normal use, such as equipping remote control means with a special button light and/or cover flaps. However, the aforementioned system disclosed by document US 2002/0015107 A1 for accessing teletext information is unsatisfactory when acknowledging or canceling received control commands by using the aforementioned visual prompt, since the special buttons for acknowledgement or canceling do in fact constitute a source of new errors; this design is also deficient with respect to acknowledgement when no information is available relating to the previously received control command, for example no notification message.

### OBJECT AND SUMMARY OF THE INVENTION

It is an object of the invention to remedy this situation and to improve a system of the generic type mentioned in the introduction, so that the improved system allows individuals to verify and acknowledge received control commands in a straightforward way in order to activate those functions of the controllable system, which are in fact intended.

It is another particular object to make do with buttons already available for the input of control commands, and not to necessitate any additional acknowledgement or cancel buttons.

It is also an object of the invention to provide an acknowledgement prompt in the form of notification, in particular visual notification, so that the notification uniquely indicates the control command, which has been entered, and is unequivocally perceptible by optical means.

According to a primary aspect of the invention, an arrangement according to the invention is provided with features according to the invention so that a system according to the invention may be characterized as indicated below:

A controllable system having functions that can be activated by control commands, which system contains the following means: input means for control commands and acknowledgment signals, and recognition means connected to the input means in order to recognize received control commands, and detection means for detecting a received acknowledgment signal, and request means for requesting an acknowledgment signal for a previously received control command, and command information storage means for storing individual command information items representative of the respective control command to be acknowledged, and control means which are connected to the recognition means and which, for the respective control command recognized by the recognition means and to be acknowledged, are intended to read out the individual command information representative of this control command from the storage means and deliver it as acknowledgment request information to the request means in order to request an acknowledgment signal.

In this controllable arrangement, each control command is therefore provided with particular representative command information, which is stored in associated command information storage means. When a control command is sent, the individual information item belonging to this control command is read out from the command information storage means and reproduced as information to request—for example optically and/or acoustically—an acknowledgement of the control command sent just before. Unique notification about the control command sent and to be acknowledged is therefore obtained, whereby the control command is uniquely identified so that it is also possible to check whether the actually intended control command was previously sent (or whether the wrong control button was pressed) and to therefore facilitate the decision as to whether or not the sent control command should be acknowledged.

It should be explicitly mentioned here that it is of course not necessary for all the control commands provided in the controllable system to be acknowledged in the aforementioned way, but that it is conceivable to allow control commands without acknowledgement in a wide variety of controllable systems, such as TV systems, stereos and similar consumer electronics, for instance in order to turn up or down the volume of an acoustic playback or in order to start an automatic station search up or down. An acknowledgement procedure with notification will, however, be expedient with those control commands which entail direct function switching, for instance switching from a first station to a second station or generally switching to another information source or a previous information source.

The respective notification or request for an acknowledgement signal may be carried out optically and/or acoustically, depending on the type of controllable system. Where possible, it is preferable to provide a visual notification and request for an acknowledgement signal, in which case a TV screen of the TV system itself may be used for this in the case of a TV system; there are, however, many consumer electronics systems which are not yet equipped with a video screen but still with displays, for instance an LCD display (liquid crystal display) or the like, and optical notification and acknowledgement prompting may therefore be carried out using such a display. In these cases, it is preferable to carry out acoustic prompting for acknowledgement as well, using available loudspeakers or headphones. Appropriate individual command information items are therefore stored as video data and/or audio data in the command information storage means and, following the reception or input of a corresponding control command, the control means establish the associated memory address and then read out the information belonging to the control command, for example the “command information”, from the acknowledgement information storage means using the address assigned in this way and deliver it as acknowledgement request information to the relevant optical or acoustic means in order to request an acknowledgement signal.

According to the technology according to the invention, the acknowledgement is carried out in a particularly advantageous way by repeating the control command previously sent, that is to say a control button previously actuated to send the control command is pressed again for acknowledgement, with a predetermined time window preferably being provided for this, for example a time interval, example given a time interval of about three (3) seconds, within which the control command acknowledgement must take place. If this time interval elapses and the control button is not pressed—as an acknowledge button—until later, then this subsequent actuation is interpreted as an intention to send a new control command, and acknowledgement is again prompted so that the predetermined time interval starts to run again.

In such an embodiment of a controllable arrangement according to the invention, in which the control commands previously sent need to be repeated for acknowledgement, it is therefore advantageous that the detection means for detecting an acknowledgement signal should be formed by comparator means which receive data that relate to the respective control command from the control command recognition means, and which are furthermore connected to temporary storage means for data relating to a respective previously received control command, which temporary storage means are connected to the control command recognition means, the comparator means being provided to receive the data of the respective previously received control command from the temporary storage means and compare them with the data of a control command resent as an acknowledgment signal. If the two control command data match, then a control signal is emitted for activating the intended function of the device. The data being compared in the comparator means may, for example, be the stored code signals which are assigned to the control commands and which are transmitted by remote control means, for example using infrared, or the address data associated with the code signals, i.e. it is of course not necessary to provide the comparator means with all the command information.

It has been found particularly preferable for video information to be reproduced in the course of notification and prompting to acknowledge a sent control command, these video information items representing the control button assigned to the control command in question, for example the button pressed on the remote control means or the button on the system itself. This provides immediately comprehensible optical notification and prompting, since button symbols can be recognized quickly. In this case, it is also preferable to display the control buttons next to the pressed control button in the respective keypad, for instance on the remote control means, in which case the previously pressed control button may be highlighted in the representation, for example by being centrally arranged in the image and/or by a stronger color intensity, so as to make it easier to recognize this control button and find it in the keypad. When only displaying button arrangements with symbols, short supplementary text may furthermore be reproduced, for instance the name of a TV channel, the text “timer” etc., in combination with the control button image.

In the event that a video screen is available and if images are already being displayed on the screen, then the visual reproduction of the acknowledgement prompt, in particular in the form of button symbols, may also be carried out by overlaid representation of this control command graphical information with the aid of a conventional so-called OSD module (OSD—on screen display), in which case a (semi-) transparent representation of the information relating to notification and prompting for acknowledgement is conceivable, so that images such as a television film actually being reproduced are obscured less.

The prompt to send an acknowledgement signal is terminated immediately after the acknowledgement signal is sent, and this is done by the control means.

It is particularly preferable that the controllable arrangement can be switched between a normal control mode, in which acknowledgement of control commands is not necessary, and the aforementioned acknowledgement mode. Appropriate switching means are therefore provided in a preferred embodiment, which may in particular be assigned to the control means.

These and other aspects of the invention are apparent from and will be elucidated with reference to the embodiments described hereinafter, to which however the invention is not limited.

### BRIEF DESCRIPTION OF THE DRAWINGS

In the drawings

FIG. 1 schematically shows a block diagram of a controllable arrangement according to the invention, in the form of a television system with a DVD playback system.

FIG. 2 shows an exemplary view of a TV set constituting a controllable arrangement, with a control button image display for visual notification and simultaneous prompting to send an acknowledgement signal.

FIG. 3, also in the form of a block diagram, illustrates some details of a controllable arrangement relating to the control command acknowledgement.

Combined FIGS. 4a and 4b show a flow chart of a process for acknowledging or canceling control commands.

FIG. 5 shows a flow chart of the procedure for configuring a controllable arrangement in order to store the relevant command information, for instance when installing a new remote controller.

### DESCRIPTION OF EMBODIMENTS

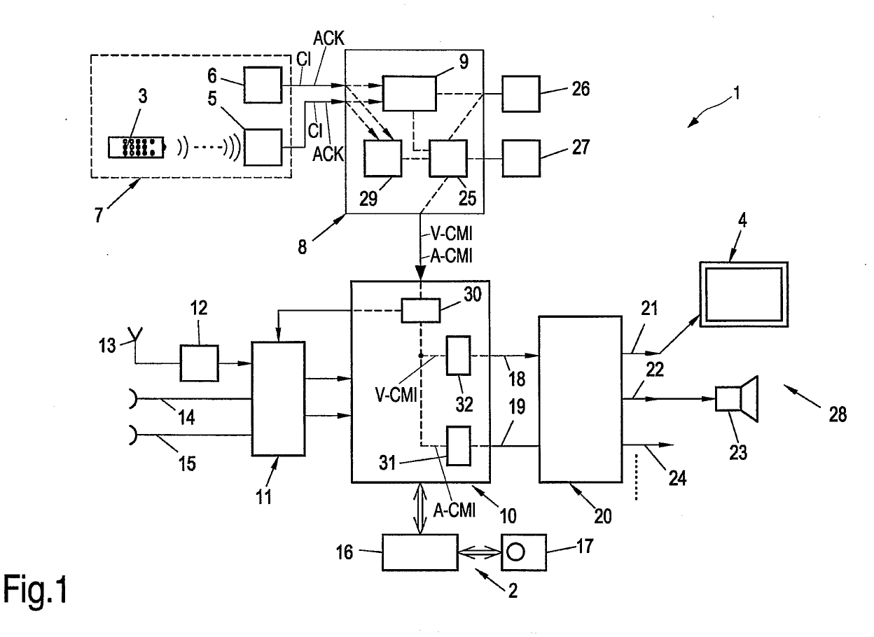

FIG. 1 schematically illustrates a controllable arrangement 1, which in this case is a TV system with a DVD unit 2, with remote control means 3 and with image reproduction means 4, a TV screen being provided as the image reproduction means 4. The arrangement 1 furthermore contains reception means 5 for remote control commands, for example transmitted using infrared, and an input keypad 6 provided on the arrangement 1 itself, that is to say on the TV system. The remote control means 3, reception means 5 and the input keypad 6 form input means 7, which are illustrated in FIG. 1 by a box shown in dashes. These input means 7 are connected to control processor means 8, which processor means 8 contain recognition means 9 for recognizing control commands delivered via the input means 7. By pressing the intended control buttons, for instance on the remote control means 3 or on the input keypad 6, corresponding control commands CI are delivered in the form of code signals to the control processor means 8, and these control commands CI or code signals are recognized by the recognition means 9 and delivered to further signal processing, as will be described in more detail below. The arrangement 1 furthermore contains signal processing means 10, which are intended and designed to process the control commands, in particular. The signal processing means 10 are to be used for activating a function corresponding to the respective control command CI, for example switching to another station channel or changing the volume, brightness etc. of playback.

In the embodiment shown, the signal processing means 10 are connected to an input stage 11 for input selection and channel selection, this input stage 11 being in turn connected via a tuner 12 to an antenna 13 and furthermore having a digital video input 14 and a Scart input socket 15 in a conventional manner which is known per se. The signal processing means 10 are furthermore connected to the DVD unit 2, this DVD unit 2 specifically containing a DVD read/write system 16 and a DVD drive 17 connected thereto. The signal processing means 10 also have a video output 18 and an audio output 19, and these outputs 18, 19 are connected to audio/video output processor means 20 by which, also in a conventional fashion, the image reproduction can finally be carried out via a video output 21 by the image reproduction means 4 and sound reproduction can be carried out via an audio output 22 by the sound reproduction means 23. In the conventional way, other outputs such as S-video, Scart and similar outputs may be provided on the output processor means 20; FIG. 1 indicates an S-video output 24 as an example of such a further output.

Besides the recognition means 9 for recognizing sent control commands, the control processor means 8 also contain control means 25 which, when a received control command CI has been recognized, search in a related address storage means 26 for addresses of associated memory locations in command information storage means 27 and then read out individual command information items from the command information storage means 27 with the aid of these addresses. In the case of control commands to be acknowledged, it is important that each of these control commands CI for which acknowledgement is required should be provided with separately assigned individual command information items representative of this control command CI, in the form of video command information V-CMI and/or audio command information A-CMI, this respective command information item then being delivered to associated display means and/or reproduction means as notification about the input of the control command, and in particular as acknowledgement request information. In order to request such an acknowledgement signal ACK, there are request means 28 which in this case are preferably formed by the reproduction means already provided, for example in particular by the image reproduction means 4 (TV screen or video screen) and the sound reproduction means 23. In this case, the request means 28 for requesting an acknowledgement signal ACK are used for the notification as well, and may therefore also be referred to as notification means.

Furthermore, the control processor means 8 also contain detection means 29 for detecting an acknowledgement signal ACK, which is sent via the input means 7 as a result of a corresponding prompt by the request means 28 used for the notification, and preferably within a prescribed maximum time. If acknowledgement of a control command sent previously and to be acknowledged is thereby carried out in time, the control processor means 8 terminate the visual or acoustic reproduction of the command information on the request means 28 being used for the notification, and a control signal representing the intended control command CI is delivered to the signal processing means 10 in order to activate the intended function of the system 1 in the conventional way via these signal processing means 10.

For delivering the respective command information from the command information storage means 27 to the request means 28 being used for the notification, the signal processing means 10 are provided with a corresponding control unit 30 which feeds the corresponding video information and audio information to the outputs 18, 19 of the signal processing means 10. A so-called OSD module 32 is preferably provided in the graphical information path in order to overlay a video command information item V-CMI read out from the command information storage means 27 over the images currently being reproduced per se on the image reproduction means 4. Such an OSD module 32, also referred to as an OSD engine, is conventional per se and does not require further description here. The graphical information overlay may preferably be such that the overlaid image is substantially transparent so that the video images being reproduced “behind”, for instance of a TV film, are not completely obscured but still remain visible.

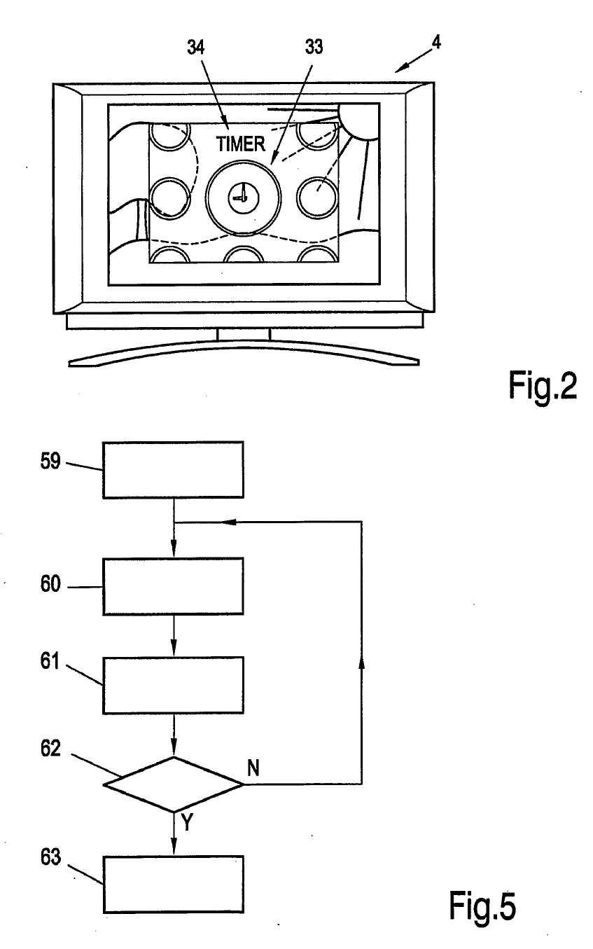

The video command information items V-CMI delivered to the image reproduction means 4, that is to say the TV screen in this case, preferably represent the respective control button which was pressed in order to send the intended control command CI; this is shown in FIG. 2. Adjacent control buttons of the respective keypad (either on the remote control means 3 or on the input keypad 6) are preferably also reproduced, as shown in FIG. 2 where a control button 33 assigned to a timer function is centrally represented prominently in a visually perceptible or graphical way, immediately adjacent buttons also being represented in addition to this control button 33. A short supplementary text 34, the text “timer” in the example shown, is also reproduced in the embodiment shown in FIG. 2 so as to provide supplementary textual information about the control button 33 if need be.

Such optical reproduction of the respective button image as notification and as information to request an acknowledgement can be seen and understood directly at a glance by the individual in question, respectively the user. Further to this, according to another particularly preferred feature of the technology according to the invention for acknowledging the sent control command, the button actuated for sending this control command needs to be actuated again so that, by displaying a graphical representation of the previously pressed control button via the image reproduction means 4, a clearly recognizable indication is provided as to which control button should be actuated as the acknowledgement button, i.e. as the button for sending an acknowledgement signal ACK. This form of notification, and this straightforward way of sending acknowledgements, can substantially preclude errors or unintended actuations.

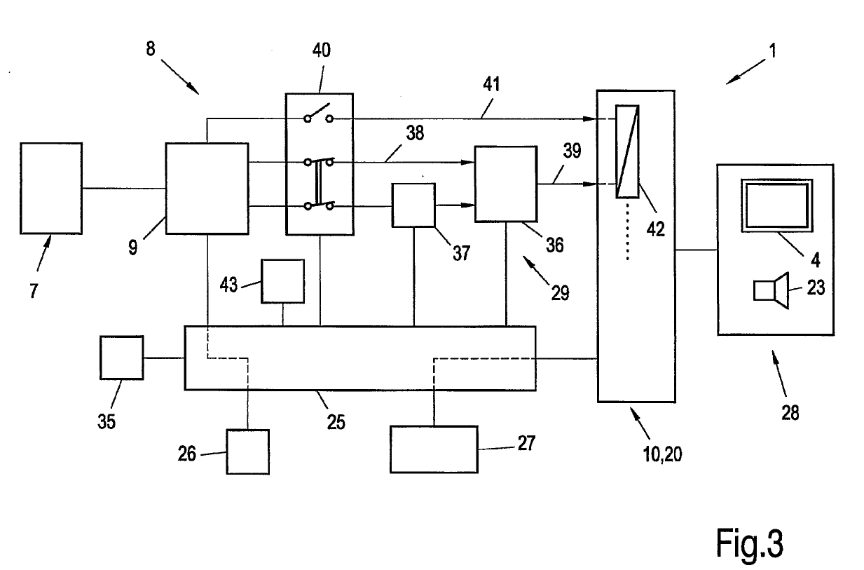

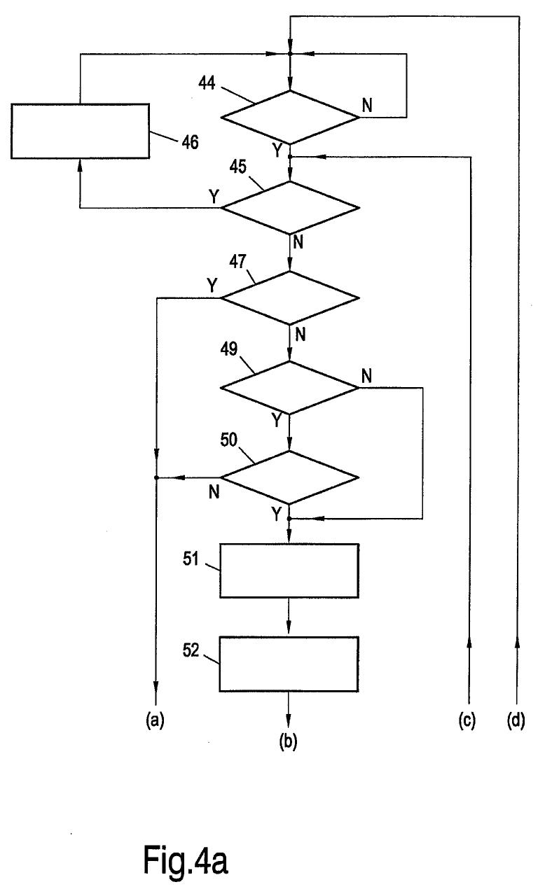

FIG. 3 schematically illustrates a part of a controllable arrangement 1, similar as shown in FIG. 1, with extra details being illustrated more clearly with respect to the control processor means 8.

As already mentioned in connection with FIG. 1, a control command CI entered via the input means 7 is registered and recognized by the recognition means 9, the memory address associated with the control command CI for the command information storage means 27 then being found in the address storage means 26 by the control means 25. By using this memory address, the corresponding video command information item V-CMI and/or audio command information item A-CMI is subsequently read out from the command information storage means 27 and delivered to the further means 10, 20 in order to finally enable a corresponding optical or acoustic notification to request an acknowledgement signal ACK for the control command, on the request means 28 also used for the notification. The purpose of this notification or reproduction of the command information as information to request an acknowledgement is that within a predetermined relatively short time interval, for example within 3 seconds, the acknowledgement signal ACK should be delivered via the input means 7 to the control processor means 8 where, with the aid of the detection means 29, it is verified so as to finally initiate the intended function of the system 1 which corresponds to the entered control command CI. The required time interval for carrying out the acknowledgement may in particular be derived from a clock signal obtained from a clock generator, which is assigned to the control means 25 and which forms a timer 35 for establishing the time interval. The time interval may then be set to a desired time by the control means 25, for instance of the aforementioned three (3) seconds or four (4) or five (5) seconds.

In the embodiment according to FIG. 3, the detection means 29 have comparator means 36 which are connected directly, on the one hand, and via temporary storage means 37 (for example a register or a RAM) on the other hand to the recognition means 9 on the input side. Like the recognition means 9, the comparator means 36 or temporary storage means 37 are connected to the control means 25 so as to control the procedures for recognizing control commands and detecting acknowledgement signals ACK, in particular while complying with the predetermined time window.

In the temporary storage means 37, an entered control command CI is temporarily stored for the predetermined time interval and the control command CI resent as an acknowledgement signal ACK is then delivered via direct connection means 38 straight to the comparator means 36 for comparison of the two control commands, which comparison is carried out on the basis of the data or code signals representing the two control commands. If the two control commands at the inputs of the comparator means 36 match, then a corresponding control signal for activating the intended function of the controllable system 1 is sent to an output 39 of the comparator means 36; at the same time, the reproduction of the command information CMI, that is to say the information to request an acknowledgement signal ACK, is terminated on the request means 28 being used for the notification.

FIG. 3 also schematically shows switching means 40, with the aid of which it is possible to switch from the acknowledgement mode, as represented and described, into a normal control mode. In the normal control mode, the output signal of the recognition means 9 is delivered directly—via connection means 41—to the means 10, 20 of the controllable system 1 in order to activate the respective function. Furthermore, FIG. 3 also schematically shows implementation means 42 within the processing and processor means 10, 20 for initiating the intended function in response to the reception of the corresponding control signals.

In cases for which the sending of a control command does not require acknowledgement of this special control command, for instance in the case of volume control, the switching means 40 may also be used to deliver this control command CI directly via the connection means 41, without activating the means intended for notification and requesting an acknowledgement. To this end, the control means 25 may be provided with control command storage means 43 in which data or codes are stored for any control commands that do not require an acknowledgement. Instead or in addition, of course, it is conceivable for the storage means 43 to store the data or codes of any control commands for which the request of an acknowledgement signal ACK is prescribed, in which case the detection means 29 and other required means will be activated by the control means 25.

Combined FIGS. 4a and 4b (the upper part of FIG. 4b follows on from the lower part of FIG. 4a) illustrate a flow chart to illustrate a possible procedure for sending a control command, for requesting and entering an acknowledgement signal ACK and for activating the function corresponding to the control command CI in the controllable system 1.

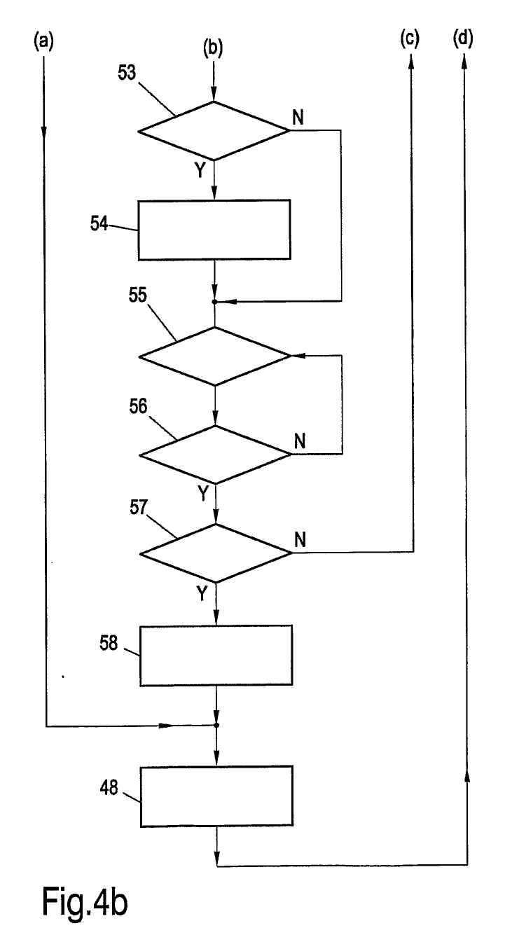

A query is made cyclically according to Block 44, for example at millisecond or centisecond intervals, as to whether a control command has been entered, for example via the remote control means 3. If a control command CI has been entered, then a query is made according to a further Block 45 as to whether the control command CI is a configuration control command for activating a new configuration, in which case a jump is made to a configuration procedure according to a Block 46, which will be explained in more detail below with reference to FIG. 5. Such reconfiguration is carried out whenever a controllable arrangement 1 is provided with new remote control means 3, for example, in which case individual control commands such as are transmitted with the aid of the remote control means 3 may be assigned different code signals than before, so that reassignment of the command information items in the command information storage means 27 has to be carried out using the address storage means 26.

According to FIG. 4a, in the case to be regarded as the normal case in which the entered control command CI is not a configuration control command CI, then a check is made in the Block 47 following Block 45 as to whether the entered control command CI is a control command CI to be carried out directly, for instance a control command CI to increase or decrease the volume or a similar function. If affirmative, then a jump is made immediately to the end of the procedure according to a Block 48 (see FIG. 4b) in which the function is activated or carried out according to the control button, which was pressed. However, if it is a control command CI requiring acknowledgement with the aid of an acknowledgement signal ACK by pressing the same control button again, then a check is made according to a Block 49 as to whether the pressed control button is a switching button. If affirmative, then a query is made according to a Block 50 as to whether the last actuation of this switching button took place more than a predetermined time interval ago, for example about three (3) seconds. If not, then the Block 48 is proceeded to (see FIG. 4b). Otherwise, if the query result in Block 49 was no, a Block 51 is proceeded to according to which the address associated with the actuated control button, or the control command CI sent using it, is read out from the address memory means 26 for the corresponding individual video information items in the command information storage means 27. Subsequently, according to a Block 52, the video information items which have been read out are delivered to the signal processing means 10, and in particular to the OSD module 32 there, and the video information, i.e. in particular—as shown in FIG. 2—the associated button image 33, is finally reproduced in a visually perceptible (semi-) transparent overlay on the image reproduction means 4 using the OSD module, optionally together with associated text information 34.

The video data may be stored in a compressed form in the command information storage means 27. Like the address storage means 26, the command information storage means 27 may be formed by so-called flash memory means. If the video information items are stored in a compressed form, then data decompression will be carried out in the signal processing means 10 or in the OSD module 32.

In continuation of the procedure, a query is made according to a Block 53 as to whether notification via a sound reproduction means 23 (loudspeaker) and a corresponding request for an acknowledgement signal ACK via loudspeaker means 23 is intended or desired. If affirmative, then a corresponding audio command information item A-CMI is also read out from the command information storage means 27 according to a Block 54, and delivered via the unit 31 to the signal processing means 10 for reproduction by the sound reproduction means 23. Here as well, the corresponding audio information is found in the command information storage means 27 after assigning the received control command to the corresponding address using the address storage means 26. The unit 31 may furthermore overlay the audio information by mixing it with an audio signal currently being reproduced.

If no audio notification is intended to take place, or if the audio notification and acoustic request for the acknowledgement signal ACK have been activated (Block 54), then a Block 55 verifies whether a time period of three (3) seconds has elapsed. If affirmative, then a query is made according to a Block 56 as to whether a new control command CI has been received. If this is not so, however, then Block 55 is returned to, that is to say another three (3) seconds are waited, and then another query is made as to whether a new control command CI has been received.

If the query according to Block 56 shows that a new control command CI has been received—as a possible acknowledgement signal ACK—however, then a query is subsequently made according to a Block 57 as to whether it is the same control command CI as the control command CI previously sent. If affirmative, then the OSD module is given the instruction according to a Block 58 to end the reproduction of the overlaid image graphic, that is to say the button image 33 together with any text information 34, and the execution of the function corresponding to the sent control command takes place according to Block 48.

If the result of the query in Block 57 is that another control button has been pressed, however, that is to say a control command other than was sent before, then there is no acknowledgement signal ACK to acknowledge the previous control command CI and the procedure returns to Block 45, according to which an initial query is made as to whether it is a configuration control command, after which the rest of the procedure takes place according to FIGS. 4a and 4b.

In practice, it is conceivable that a controllable arrangement 1 such as a TV set, a hi-fi, a video recorder, a DVD player or a combination of such systems may require resetting of control commands for which acknowledgement must take place, and of control commands without not requiring acknowledgement. The need for such reconfiguration may also arise if the remote control means 3 of an existing system 1 have to be replaced, for example when irreparable faults occur. These cases entail the (re-) assignment particularly of button images as graphical information about control buttons for the display, in particular the optical display of notifications, that is to say the video command information item V-CMI, and the request for an acknowledgement signal ACK. The same applies of course for acoustic notifications and requests for acknowledgement signals ACK.

For the sake of completeness, such a configuration procedure according to Block 46 will be explained below with reference to FIG. 5. Here, after a start Block 59, a “list” of all available control commands and all associated button images, and optionally associated acoustic information items, is communicated in a Block 60 from the remote control means 3 to the control processor means 8. In a Block 61, the video/picture and audio files are then delivered to the command information storage means 27, optionally via the signal processing means 10 where data compression is also carried out. In parallel with this, a sort of table is compiled in which the address storage means 26 are stored, and which contains the link between the control commands or their code signals, on the one hand, and the memory addresses for the button images and audio information items in the command information storage means 27.

The list of all control commands together with associated command information items may for instance be communicated from the remote control means 3 to the control processor means 8 according to Table 1 below:

TABLE 1

| | | |
|---|---|---|
| Control command #1 | JPEG #1 | Audio #1 |
| Control command #2 | JPEG #2 | Audio #2 |
| Control command #3 | JPEG #3 | Audio #3 |
| Control command #4 | JPEG #4 | Audio #4 |
| . . . | . . . | . . . |

It is assumed here that the graphical data, that is to say video data, (button images) are stored in the form of JPEG files, for example, although other image formats are of course also possible, for example GIF or TIFF.

Accordingly, the allocation between the control commands and the corresponding command information addresses is carried out in Block 61, for instance according to Table 2 below.

TABLE 2

| | | |
|---|---|---|
| Control command #1 | JPEG # address | Audio #1 address |
| Control command #2 | JPEG # address | Audio #2 address |
| Control command #3 | JPEG # address | Audio #3 address |
| Control command #4 | JPEG # address | Audio #4 address |
| . . . | . . . | . . . |

Lastly, FIG. 5 also illustrates that following Block 61, a query is made according to a Block 62 as to whether the last data record has been communicated. If this is so, then the end of the configuration procedure 46 is reached according to a Block 63, and the beginning of the procedure according to FIG. 4 is returned to. If not all the data records have yet been communicated, however, then Block 60 is returned to.

The invention was explained above in detail with reference to particularly preferred embodiments. Variants and modifications are possible within the scope of the invention, for instance optical reproduction of the notification and the acknowledgement signal request, that is to say the video command information V-CMI, being carried out using an LCD display or an LED display. It is also possible, for example, to provide only an optical notification and acknowledgement signal request. The verification of a control command using an acknowledgement signal may furthermore be carried out with the aid of a software module in a microprocessor already provided, so that an existing controllable arrangement 1 can be “retrofitted” relatively easily with the technology according to the invention.

1. A controllable system having functions that can be activated by control commands, comprising:
input means for control commands and acknowledgment signals;
recognition means connected to the input means in order to recognize received control commands;
detection means for detecting a received acknowledgment signal;
request means for requesting an acknowledgment signal for a previously received control command;
command information storage means for storing individual command information items representative of the respective control commands to be acknowledged; and
control means being connected to the recognition means (9), wherein the control means, for the respective control command recognized by the recognition means and to be acknowledged, are adapted to read out the individual command information item representative of this control command from the storage means and deliver as acknowledgment request information to the request means in order to request an acknowledgment signal.

2. A controllable system as claimed in claim 1, wherein the detection means are adapted to detect an acknowledgment signal by using comparator means, and wherein the comparator means are adapted to receive data that relate to the respective control command from the recognition means, and wherein the comparator means are furthermore connected to temporary storage means for storing data relating to a respective previously received control command, the temporary storage means being connected to the recognition means, and wherein the comparator means are adapted to receive the data of the respective previously received control command from the temporary storage means and to compare with data of a control command resent as an acknowledgment signal, and to emit a control signal in order to activate the intended function if said data match.

3. A controllable system as claimed in claim 1, wherein the request means comprise image reproduction means that are adapted for reproducing of command information items in the form of images formed by video information.

4. A controllable system as claimed in claim 1, wherein the request means comprise image reproduction means to reproduce images of command information items formed by video information, and further comprise sound reproduction means to acoustically reproduce command information items formed by audio information.

5. A controllable system as claimed in claim 3, wherein the command information storage means are adapted to store video information items representing the control buttons assigned to the control commands.

6. A controllable system as claimed in claim 3, wherein the image reproduction means are formed by a video display screen.

7. A controllable system as claimed in claim 6, wherein the image reproduction means are provided with an OSD module for overlaying alphanumeric information on the graphical information.

8. A controllable system as claimed in claim 1, wherein the control means are provided with a timer in order to define a time interval for sending an acknowledgment signal.

9. A controllable system as claimed in claim 1, wherein switching means are provided for switching the controllable system between an acknowledgment mode and a normal control mode that does not involve acknowledgment of control commands.

10. A controllable system as claimed in claim 9, wherein the switching means are assigned to the control means.

11. A controllable system as claimed in claim 1, wherein the input means are adapted as remote control means.
